(19) United States
(12) Patent Application Publication
(10) Pub. No.: US 2018/0056394 A1
(43) Pub. Date: Mar. 1, 2018

(54) MACHINE COMPONENT AND PRODUCTION METHOD THEREFOR

(71) Applicant: NTN CORPORATION, Osaka (JP)

(72) Inventors: Naoki YASHIRO, Mie (JP); Kouya OOHIRA, Mie (JP)

(73) Assignee: NTN CORPORATION, Osaka (JP)

(21) Appl. No.: 15/557,577

(22) PCT Filed: Mar. 15, 2016
(86) PCT No.: PCT/JP2016/058142

§ 371 Date: Sep. 12, 2017

(30) Foreign Application Priority Data
Mar. 19, 2015 (JP) 2015-056393
Mar. 4, 2016 (JP) 2016-042469

(51) Int. Cl. B22F 3/11; B22F 3/02; C22C 1/05; C22C 1/08; C22C 33/02; F16C 33/12

(52) U.S. Cl. CPC B22F 3/11; B22F 3/02; C22C 1/05; B22F 2003/023; C22C 33/02; F16C 33/12; C22C 1/08

(57) ABSTRACT

A machine part (an oil-impregnated bearing (1)) is obtained by subjecting a green compact to heat treatment in an oxidizing atmosphere (for example, in air), the green compact being obtained by compacting and forming raw material powder containing iron powder and copper powder. Iron particles (10) and copper particles (20) are bonded to each other with oxide films (11) and (21) formed on surfaces of the particles. The oxide films (11) and (21) each have a maximum thickness of 1 μm or less in a region at a depth of 300 μm±10 μm from a surface of the green compact.

### TECHNICAL FIELD

The present invention relates to a machine part and a method of manufacturing the same. More specifically, the present invention relates to a machine part obtained by increasing strength of a green compact, which is obtained by compacting and forming metal powder without sintering, and to a method of manufacturing the same.

### BACKGROUND ART

In the field of powder metallurgy, a product has hitherto been generally obtained by mixing raw material powders mainly including metal powder, and compacting and forming the mixed powders, followed by sintering in a furnace at a high temperature of more than 800° C. A product obtained by compacting and forming the metal powder without sintering treatment is hereinafter referred to as “green compact” and is distinguished from a sintered compact obtained by further performing sintering treatment.

According to JIS Z 2500:2000, the powder metallurgy refers to a metallurgy technology category involving production of the metal powder and manufacturing of a product through forming of the metal powder and a sintering step. The powder metallurgy is a technology different from casting and forging. In the powder metallurgy, the product is generally manufactured by the following steps.
(1) Mixing of powders serving as raw materials, such as metal powder, lubricant powder, and graphite powder
(2) Compacting and forming
(3) Sintering at a temperature equal to or lower than a melting point
(4) Correction (sizing)
(5) Post-processing, such as heat treatment or oil impregnation (as required)

Of those steps, (3) the sintering step generally includes treatment in a high temperature region of 800° C. or more in the case of an iron-based material, and the cost of this step accounts for from ¼ to ½ of the entire manufacturing cost. Further, a green compact expands or shrinks through the sintering step at high temperature, and hence (4) the correction step is indispensable in order to keep the dimensions and accuracy of the product within target dimensions and target accuracy.

In addition, the sintering step is generally performed in a non-oxidizing atmosphere of, for example, an inert gas, such as nitrogen or argon, a reducing gas, such as hydrogen, a mixed gas thereof, or vacuum, for the purpose of suppressing formation of an oxide film on the surfaces of metal powder particles during sintering, to thereby promote fusion of the particles. Through such sintering step, metal particles are fused with each other, that is, necking occurs, resulting in an increase in strength. However, when sufficient strength is secured through treatment at lower temperature, the manufacturing cost can be reduced. Besides, a dimensional change can be suppressed, and hence the correction step can be omitted.

With regard to a method of increasing the strength of the green compact without the sintering step at high temperature as described above, the following investigations have hitherto been made.

A method of strengthening a green compact disclosed in Patent Literature 1 includes compacting and forming metal powder having added thereto metal soap as a lubricant for forming, and then heating the resultant green compact at a temperature equal to or higher than the melting point of the metal soap and equal to or lower than the dewaxing temperature of the metal soap. With this, the mechanical strength of the green compact is significantly increased. The mechanism of this method is presumed as follows: the metal soap in pores in the green compact melts through the heat treatment to form a continuous layer and then solidifies, to thereby increase the strength of the green compact by virtue of the density of the layer (see Scope of claim, lines 10 to 12 in the second column, and lines 22 to 25 in the third column of Patent literature 1).

In Patent literature 2, there is a disclosure that an iron-based sintered part is manufactured by subjecting a green compact to steam blackening treatment without sintering to bond particles of the green compact to each other. The mechanism of this technology is as follows: the entire surface of the green compact is covered with an oxide film through the steam blackening treatment, and hence an object in which particles on its surface are bonded and fixed to each other and thus predetermined strength is achieved in its entirety is obtained (lines 8 to 11 in the lower left column on page 2 of Patent Literature 2). The iron-based “sintered” part disclosed in the literature is classified as “green compact” in this description because the part is not subjected to the sintering step including heating at a high temperature of 800° C. or more.

In Patent Literature 3, there is a disclosure of an iron-based machine part, in which a green compact including iron powder is heated at from 400° C to 700° C. in an oxidizing atmosphere to generate iron oxide on the surfaces of iron powder particles, to thereby bond the iron powder particles to each other with iron oxide. Specifically, first, the surfaces of the iron powder particles are oxidized through heating of the green compact, and thus iron oxide is generated on the surfaces. Then, the respective iron oxides generated fill pores in the green compact so as to form a net-like connection. Thus, the particles are firmly bonded to each other.

### CITATION LIST

Patent Literature 1: JP 61-011282 B2

Patent Literature 2: JP 63-072803 A

Patent Literature 3: JP 51-43007 B2

### SUMMARY OF INVENTION

### Technical Problem

An object of the technology disclosed in Patent Literature 1 is just to prevent chipping and breakage of the green compact during its conveyance to a sintering furnace from a forming step. The green compact does not have strength as a product as it is. Therefore, as a matter of course, there is no suggestion of omission of the sintering step. Accordingly, the green compact cannot ultimately secure enough strength for its use as a product without a subsequent sintering step at high temperature. Besides, the number of steps is increased by one as compared to a general sintered product owing to the treatment before sintering, which contrarily causes an increase in cost.

In Patent Literature 2, there is a disclosure that an increase in strength is achieved by subjecting the green compact to the steam blackening treatment to form the oxide film. However, there is no disclosure about how much strength is actually obtained. The application of the iron-based sintered part is limited to those requiring less strength, such as a soft magnetic material part given as a specific example. In addition, in a steam atmosphere, the oxide film is easily formed on a surface of each metal powder particle, and thus most of the inner pores of the green compact are filled therewith. Such configuration is not preferred in some applications. For example, when a part as described above is used as an oil-impregnated bearing having inner pores impregnated with an oil, the amount of oil contained in its inside is reduced owing to the inner pores filled with an oxide, and hence there is a risk in that sufficient lubricity cannot be obtained,

Similarly, also the technology disclosed in Patent Literature 3 is not preferred in some applications because the green compact is heated in the oxidizing atmosphere to form the oxide, and thus the inner pores of the green compact are filled with the oxide.

In view of the above-mentioned circumstances, an object of the present invention is to impart a sufficient strength and ensure inner pores in a machine part comprising a green compact in which metal powder particles are bonded to each other with an oxide film. Herein, a part having a radial crushing strength according to “Sintered metal bearing-Determination of radial crushing strength” of JIS Z 2507 of 120 MPa or more has strength enough to withstand the use as a machine part.

### Solution to Problem

In order to achieve the above-mentioned object, a machine part according to one embodiment of the present invention comprises a green compact in which metal powder particles are bonded to each other with an oxide film formed on a surface of each particle, wherein a maximum thickness of the oxide film in a region at a depth of 300 μm±10 μm from a surface of the green compact is 1 μm or less.

In order to achieve the above-mentioned object, a method of manufacturing a machine part according to one embodiment of the present invention comprises the steps of: compacting and forming raw material powder containing metal powder to provide a green compact; and subjecting the green compact to heat treatment in an oxidizing atmosphere to allow metal powder particles to be bonded to each other with an oxide film formed on a surface of each particle, conditions of the heat treatment being set so that a maximum thickness of the oxide film in a region at a depth of 300 μm±10 μm from a surface of the green compact is 1 μm or less.

As described above, in the embodiments of present invention, the maximum thickness of the oxide film formed on the surface of each metal powder particle is set to 1 μm or less in an inside of the green compact, specifically in a region at a depth of about 300 μm from the surface of the green compact, more specifically in a region at a depth of 300 μm±10 μm from the surface. According to the investigations made by the inventors of the present invention, it is revealed that even the oxide film having an extremely small thickness as described imparts a strength required for the machine part (specifically, a radial crushing strength of 120 MPa or more). When the oxide film, is made thin as described above, a ratio at which the inner pores of the green compact are filled with the oxide film is reduced, and hence a sufficient porosity of the green compact can be ensured.

In the machine part, it is preferred that the maximum thickness of the oxide film in a surface layer of the green compact (specifically, in a region at a depth of 30 μm or less from the surface of the green compact) be twice or more as large as the maximum thickness of the oxide film in the inside of the green compact (specifically, in the region at a depth of 300 μm±10 μm from the surface of the green compact). When the oxide film formed in the surface layer of the green compact is made thick as described above, improvements in rust resistance and corrosion resistance can be expected.

The machine part according to the embodiment of the present invention may comprise, for example, a green compact comprising only iron as a main component or a green compact comprising iron and copper as a main component.

An example of a possible oxidizing atmosphere in the heat treatment of the green compact is a steam atmosphere. However, when the green compact is heated in a steam atmosphere, the oxide film is easily formed on the surface of each metal powder particle, and hence it becomes difficult to control the thickness of the oxide film in the inside of the green compact to 1 μm or less. In addition, in order to introduce a sufficient amount of steam in a furnace and retain the furnace at high temperature and high pressure, a large-scale facility is required and cost is increased. In view of the foregoing, it is preferred that the heat treatment of the green compact be performed in an oxidizing atmosphere in which the formation rate of the oxide film is lower than in the steam atmosphere, specifically in any one of an oxygen atmosphere, an air atmosphere, and an atmosphere of an oxidizing gas obtained by mixing an inert gas with oxygen or air. The air atmosphere includes an atmosphere obtained by supplying pure air into a furnace, and an atmosphere of the atmosphere without atmosphere control.

When the oxide film in the inside of the green compact is made thin as described above, the green compact can have a porosity of 8% or more.

The machine part can suitably be used as an oil-impregnated bearing having inner pores impregnated with an oil, particularly as an oil-impregnated bearing comprising a dynamic pressure generating portion, such as a dynamic pressure groove, in a bearing surface.

### Advantageous Effects of Invention

Thus, according to the present invention, a sufficient strength can be imparted and inner pores can be ensured in the machine part comprising a green compact in which metal powder particles are bonded to each other with an oxide film.

### BRIEF DESCRIPTION OF DRAWINGS

FIG. 1 is a sectional view of an oil-impregnated bearing as a machine part according to one embodiment of the present invention.

FIG. 2A is a photograph of a sectional structure of the oil-impregnated bearing in a surface layer.

FIG. 2B is a photograph of a sectional structure of the oil-impregnated bearing at a depth of about 300 μm from the surface layer.

FIG. 3A is an enlarged photograph of a sectional structure of an oil-impregnated bearing according to Comparative Example in a surface layer.

FIG. 3B is an enlarged photograph of a sectional structure of the oil-impregnated bearing shown in FIG. 3A at a depth of about 300 μm from the surface layer.

FIG. 4A is an enlarged photograph of a sectional structure of an oil-impregnated bearing according to another embodiment of the present invention.

FIG. 4B is an enlarged photograph of a sectional structure of the oil-impregnated bearing shown in FIG. 4A at a depth of about 300 μm from a surface layer.

### DESCRIPTION OF EMBODIMENTS

Now, description is given of a case in which a machine part according to the present invention is applied to an oil-impregnated bearing having inner pores impregnated with an oil.

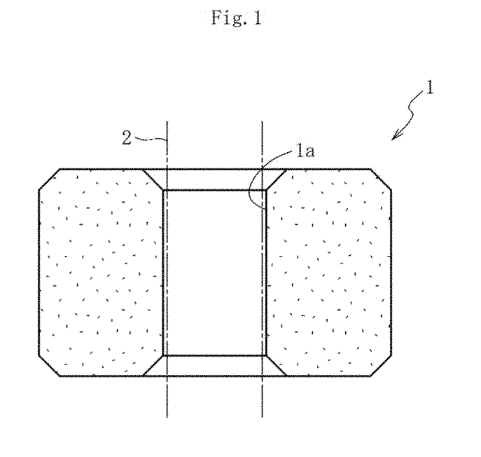

An oil-impregnated bearing 1 illustrated in FIG. 1 is formed of a cylindrical green compact, and its inner pores are impregnated with an oil. An inner peripheral surface 1a of the oil-impregnated bearing 1 functions as a bearing surface configured to support a shaft 2 inserted into an inner periphery. When the shaft 2 rotates, the oil contained in the inner pores of the oil-impregnated hearing 1 seeps out onto a slide portion between the oil-impregnated bearing 1 and the shaft 2 along with an increase in temperature. With this, the oil is always abundantly supplied to the slide portion, and thus lubricity is improved.

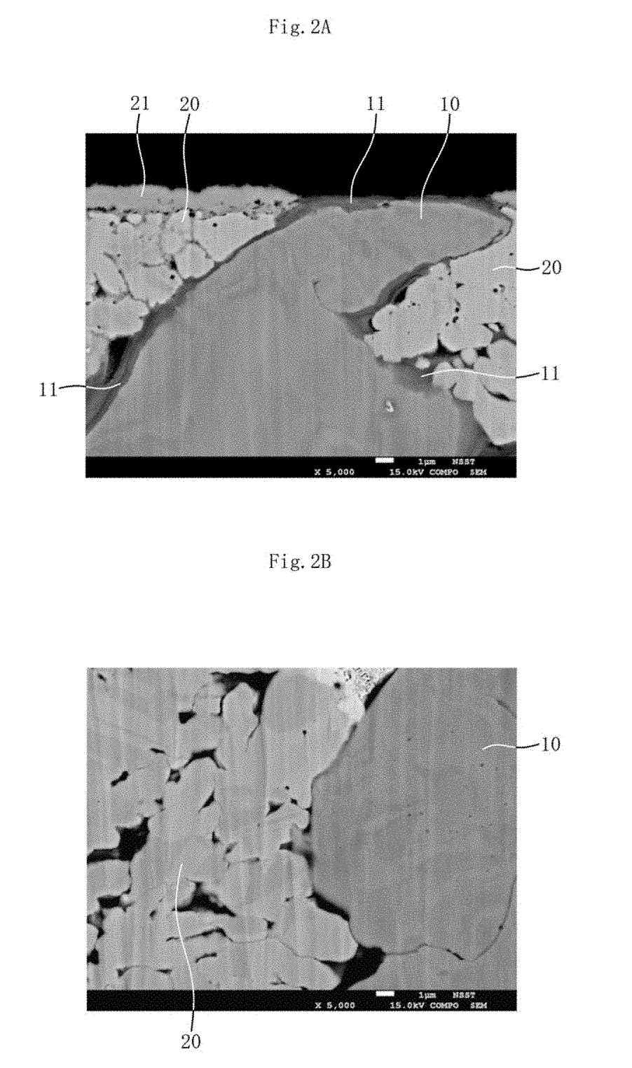

The green compact for forming the oil-impregnated bearing 1 of this embodiment comprises iron powder and copper powder as a main component. FIG. 2A and FIG. 2B are each an enlarged photograph {a backscattered electron (BSE) image of FE-SEM} of a sectional structure of a product obtained by subjecting a green compact corresponding to Example 17 described later, specifically a green compact having a composition of Fe+60% Cu, to oxidation treatment at 500° C. for 30 minutes in an air atmosphere. FIG. 2A is a sectional photograph in a surface layer, one FIG. 2B is a sectional photograph in an inside (at a depth of about 300 μm from a surface). In the figures, particles having relatively smooth surfaces (darker-shaded particles) represent iron particles 10, and dendritic, particles (lighter-shaded particles) represent copper particles 20. An iron oxide film 11 and a copper oxide film 21 are formed on each of the surfaces of the iron particles 10 and each of the surfaces of the copper particles 20, respectively. With the oxide films 11 and 21, the respective iron particles 10, the respective copper particles 20, or the iron particles 10 and the copper particles 20 are bonded to each other. Not all the particles are bonded to each other with the oxide films 11 and 21, and part of the particles are brought into direct contact with each other without the oxide films 11 and 21 and fused to each other.

In the sectional photograph of the green compact in the surface layer shown in FIG. 2A, the formation of the oxide films 11 and 21 can be clearly observed on the surfaces of the iron particles 10 and on the surfaces of the copper particles 20, respectively. Meanwhile, in the sectional photograph of the green compact in the inside shown in FIG. 2B, the existence of the oxide films can hardly be observed. However, when a sectional surface of an actual green compact is visually observed, blackening resulting from oxidation is observed in its inside as well, and hence the oxide films are undoubtedly formed on the surfaces of the particles in the inside. From those facts, it is considered that an oxide film having an extremely small thickness is formed in the inside of the green compact. The maximum thickness of the oxide film in the inside (for example, in a region at a depth of 300 μm±10 μm from the surface of the green compact) is considered to be at least 1 μm or less, 0.5 μm or less, or further 0.3 μm or less because the oxide film is present to such extent that its observation is difficult in FIG. 2B. Even when the oxide film in the inside has an extremely small thickness as described above, a strength required for a machine part, such as an oil-impregnated bearing, specifically a radial crushing strength of 120 MPa or more is exhibited. The “maximum” thickness of the oxide film refers to a maximum thickness of the oxide films in which an incidentally formed local portion having a large thickness is excluded.

When the oxide film in the inside of the green compact has an extremely small thickness as described above, a sufficient porosity of the oil-impregnated bearing 1 can be ensured. Specifically, the porosity of the oil-impregnated bearing 1 can be set to 8% or more, preferably 11% or more. With this, the inner pores of the oil-impregnated bearing 1 can be impregnated with a sufficient amount of oil. In addition, it is desired to set the porosity of the oil-impregnated bearing 1 to 27% or less, preferably 24% or less in order to ensure the strength. The porosity is measured by the following method. When the dry density of a green compact measured and calculated by an Archimedes method specified in JIS Z 2501:2000 is defined as ρ (dry), and the true density of base material powder (excluding lubricant powder) for forming the green compact is defined as ρ (powder), the porosity is calculated based on the ratio between these densities by using the following equation.

Porosity (%)=100−{ρ(dry)/ρ(powder)}×100

For example, when the dry density of a green compact formed only of Fe powder after heat treatment is 5.8 g/cm³, the porosity is as follows: 100−(5.8/7.87)×100≈26.3%.

In addition, it is apparent from FIG. 2A and FIG. 2B that the maximum thickness of the oxide film in the surface layer of the green compact (for example, in a region at a depth of 30 μm or less from the surface) is larger than the maximum thickness of the oxide film in the inside of the green compact. The maximum thickness of the oxide film in the surface layer is considered to be at least twice or more, five times or more, further ten times or more as large as the maximum thickness of the oxide film in the inside. When the oxide film formed on the surface of each particle in the surface layer has a relatively large thickness as described above, improvements in anti-rust effect and corrosion resistance can be expected. As described above, when, in the green compact for forming the oil-impregnated bearing 1, the oxide film in the inside is made extremely thin and the oxide film in the surface layer is made thick, the oil-impregnated bearing 1 which is excellent in rust resistance and corrosion resistance and has high lubricity can be obtained.

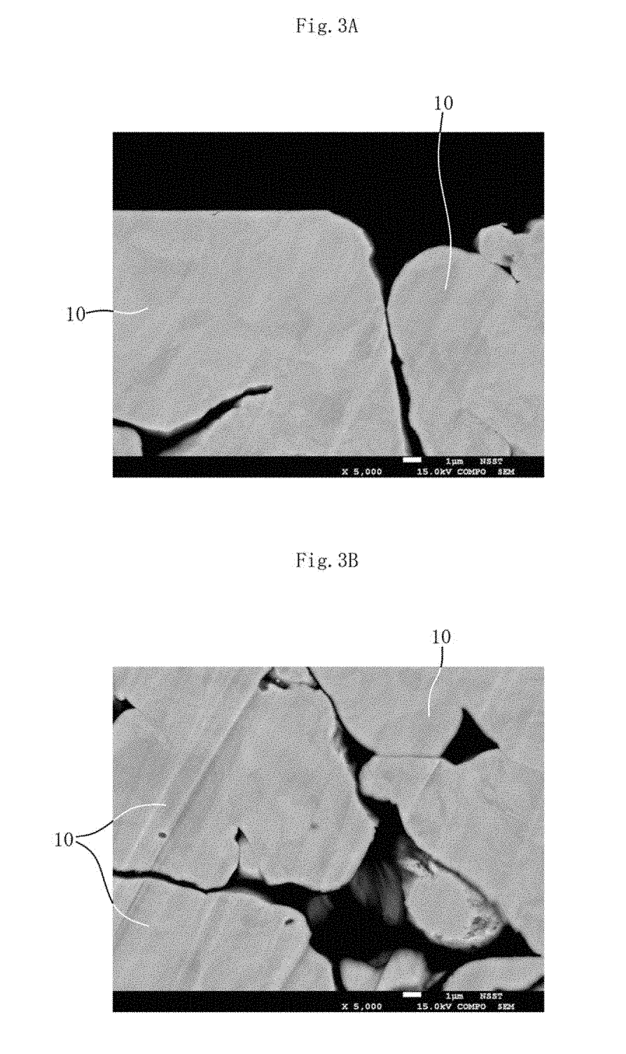

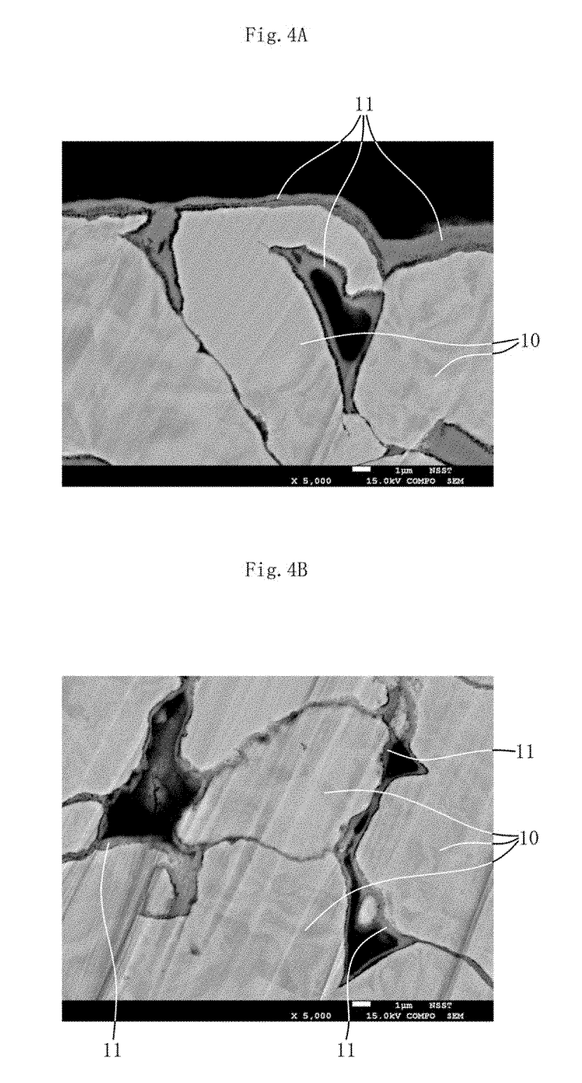

Such a phenomenon as described above is observed also in the case of an iron-based green compact formed mainly of iron powder. FIG. 3A and FIG. 3B are each an enlarged photograph of a sectional structure of a green compact formed only of iron powder having been subjected to heat treatment in a nitrogen atmosphere (corresponding to Comparative Example 9 described later), and FIG. 4A and FIG. 4B are each an enlarged photograph of a sectional structure of a green compact formed only of iron powder having been subjected to heat treatment in a nitrogen/oxygen two-component mixed atmosphere having an oxygen fraction of 20 vol % (corresponding to Example 26 described later). A sectional surface in a surface layer is shown in FIG. 3A and FIG. 4A, and the sectional surface in an inside (at a depth of about 300 μm from a surface) is shown in FIG. 3B and FIG. 4B. In the green compact shown in FIG. 3A and FIG. 3B, no oxide film is observed on the surfaces of the iron particles 10 in the surface layer and in the inside. Meanwhile, in the green compact shown iIn FIG. 4A and FIG. 4B, the oxide film 11 is formed on the surfaces of the iron particles 10 in the surface layer and in the inside. In the green compact shown in FIG. 4A and FIG. 4B, it is apparent that the oxide film 11 is thicker in the surface layer than in the inside, and the maximum thickness in the surface layer is at least twice or more as large as the maximum thickness in the inside. With this, similar effects to those described above can be obtained.

The oil-impregnated bearing 1 is manufactured through a mixing step, a compacting step, a degreasing step, an oxidation step, and an oil impregnation step. Now, the steps are described in more detail.

(1) Mixing Step

A mixing step is a step of mixing various metal powders to produce raw material powder. The raw material powder contains as a main component iron powder or copper powder, or both of the powders. In this embodiment, the raw material powder contains iron powder and copper powder. The iron powder may be used irrespective of its production method (for example, an atomizing method, a reduction method, a stamping method, or a carbonyl method). Also the copper powder may be used irrespective of its production method (for example, an electrolysis method, an atomizing method, a reduction method, or a stamping method). In addition, alloyed powder containing iron or copper as a main component (for example, pre-alloyed powder which is preliminarily alloyed, or partially diffusion-alloyed powder which is partially diffusion-alloyed), or pre-mixed powder which is obtained by preliminarily mixing a plurality of kinds of metal powders may also be used. In addition, low-melting point metal powder, such as Sn or Zn, or carbon-based powder, such as graphite or carbon black, may be added to the raw material powder in order to, for example, improve the lubricity and increase the strength.

Further, a lubricant may be added to the raw material powder so that lubrication is ensured between the raw material powder and a mold or between the particles of the raw material powder in a compacting step described below. As the lubricant, metal soap, amide wax, or the like may be used. It is appropriate that the lubricant as powder be mixed in the raw material powder. It is also appropriate that the lubricant listed above be dispersed in a solvent, and the resultant solution be sprayed onto the metal powder or the metal powder be immersed in the solution, followed by removal of a solvent component through volatilization, to thereby coat the surface of the metal powder with the lubricant.

(2) Compacting Step

A compacting step is a step of supplying the raw material powder produced in the mixing step into a mold, and compacting and forming the raw material powder to provide a cylindrical green compact. A method for the compacting step is not particularly limited, and uniaxial press forming, and as well, forming with a multiaxial CNC press, injection molding (MIM), or the like may be applied.

In general, a sintered part having a higher density has higher strength. However, when an increase in strength is to be achieved through oxidation treatment of the green compact as in this embodiment, an excessively high green density may cause a decrease in strength contrarily because an oxidizing gas, such as air, cannot penetrate into the inside of the green compact, and the formation of the oxide film is limited to only the surface layer of the green compact. From the above-mentioned viewpoint, it is desired to set the green density to 7.2 g/cm³ or less, preferably 7.0 g/cm³ or less. Meanwhile, an excessively low green density may cause occurrence of chipping or breakage at the time of handling (a large rattler value), and less formation of the oxide film between the particles owing to an excessively long distance between the particles. From the above-mentioned viewpoint, it is desired to set the green density to 5.8 g/cm³ or more, preferably 6.0 g/cm³ or more. The green density is measured by a dimension measurement method.

(3) Degreasing Step

A degreasing step is a step of heating the green compact to remove a lubricant component contained in the green compact (dewaxing). The degreasing step in this embodiment is performed at a temperature higher than the decomposition temperature of the lubricant and lower than the temperature of an oxidation step described below. For example, the degreasing step is performed through heating at 350° C. for 90 minutes. In the related-art methods, the lubricant component contained in the green compact is decomposed through retention at high temperature in a subsequent sintering step, and hence is not contained in a product after sintering. However, when the present invention is applied, the lubricant component may remain depending on the density of the green compact, a treatment temperature, and a retention time period. Therefore, it is desired to adopt such a method that the degreasing step for decomposing and removing the lubricant component is provided in advance prior to the oxidation treatment and the oxidation treatment is successively performed in the same atmosphere after the degreasing step. However, it has been found that an increase in strength can be achieved even when the oxidation treatment is performed with the lubricant contained without performing the degreasing step. Alternatively, the degreasing step may be performed with a separate heating device in an atmosphere different from that in the oxidation step (for example, in an inert gas, a reducing gas, or vacuum).

(4) Oxidation Step

An oxidation step is a step of heating the green compact in an oxidizing atmosphere to form the oxide film on the surface of each particle of the metal powder (particularly, iron powder and copper powder serving as a main component), to thereby bond the particles to each other with the oxide film and thus increase the strength of the green compact. In this embodiment, the treatment conditions of the oxidation step (a heating temperature, a heating time period, and a heating atmosphere) are set so that the oxide film described above is obtained. Specifically, in the oxidation step in this embodiment, the heating temperature is set to 350° C. or more, preferably 450° C. or more. In addition, the heating temperature is set to preferably 600° C. or less because an excessively high heating temperature causes a large dimensional change in the green compact. The heating time period is appropriately set within a range of from 5 minutes to 2 hours. An oxidizing atmosphere is adopted as the heating atmosphere in order to promote positive oxidation. It is preferred to adopt an oxidizing atmosphere exhibiting a formation rate of the oxide film lower than that in a steam atmosphere because the steam atmosphere exhibits a high formation rate of the oxide film and thus the thickness of the oxide film in the inside is liable to exceed 1 μm. Specifically, the heating is preferably performed in any one of an air atmosphere, an oxygen atmosphere, and an atmosphere of an oxidizing gas obtained by mixing an inert gas, such as nitrogen or argon, with air or oxygen. When the heating atmosphere has an oxygen fraction of 2 vol % or more, a radial crushing strength of 120 MPa or more is obtained, with which the machine part to be obtained is enough to withstand the use as a machine part, such as an oil-impregnated bearing.

An iron oxide film formed on the surface of the iron powder is formed of a mixed phase of two or more kinds of Fe₃O₄, Fe₂O₃, and FeO. A copper oxide film formed on the surface of the copper powder is formed of a mixed phase of two or more hinds of CuO, Cu₂O, and Cu₂₊₁O. The ratio between those oxide films varies depending on one materials and treatment conditions.

Through the oxidation step, the oxide film formed on the surfaces of the metal powder particles forms a network spreading between the metal powder particles. Thus, the oxide film substitutes for a conventional bonding force obtained from sintering at high temperature, and results in an increase in strength of the green compact. In addition, in this embodiment, not all the particles of the iron powder and copper powder serving as a main component are bonded to each other with the oxide film, and part of the particles are brought into direct contact with each other without the oxide film and fused to each other. The strength of the green compact after the oxidation step is set to a strength required for a sintered machine part, such as an oil-impregnated bearing or a slide member, specifically a radial crushing strength of 120 MPa or more, preferably 150 MPa or more.

An increase in strength through the oxidation step can be exhibited in a green compact formed of iron, copper, or a material obtained by mixing iron and copper at various ratios (an iron-based material, a copper-based material, an iron-copper-based material, or a copper-iron-based material) used in a conventional general sintered member. Therefore, the oxidation step is applicable irrespective of the blending ratio of copper and iron. For example, the oxidation step is applicable even to a copper-iron-based green compact having a copper ratio of 59 wt. % or more.

The above-mentioned oxidation step is performed at a treatment temperature lower than that in the conventional sintering step at high temperature. As a result, a dimensional change is small, and hence a subsequent correction (sizing) step can be omitted depending on a material, treatment conditions, a product shape, dimensions, and the like. With this, a manufacturing process is shortened, a reduction in cost can be achieved, and design of a product and a mold for compacting and forming is facilitated.

The oxidation step is applicable irrespective of the shape and dimensions of the green compact. In addition, the surface of the green compact having been subjected to the oxidation step is coated with the oxide film. As a result, a high anti-rust effect is exhibited, which eliminates the need for anti-rust treatment in some cases. In addition, the treatment temperature in the oxidation step is relatively low, and hence an additive that is altered or decomposed at a temperature higher than the treatment temperature (for example, a material exhibiting slidability or lubricity) maybe added, to thereby highly functionalize a product.

(5) Oil Impregnation Step

An oil impregnation step is a step of allowing the inner pores of the green compact having been subjected to the oxidation treatment to be impregnated with a lubricating oil. Specifically, the green compact, is immersed in the lubricating oil in an environment at reduced pressure, and then the pressure is returned to the atmospheric pressure. Thus, the lubricating oil penetrates into the inner pores of the green compact. At this time, the inner pores or the green compact can be impregnated with a sufficient amount of oil because the thickness of the oxide film formed in the inside of the green compact is 1 μm or less and thus a sufficient porosity of the green compact is ensured. Through the above-mentioned steps, the oil-impregnated bearing 1 according to this embodiment is completed.

The oil-impregnated bearing described above is not limited to a bearing configured to contact support a shaft, and may be a bearing configured to non-contact support the shaft by the action of dynamic pressure of an oil filled in a radial bearing gap with the shaft. In this case, a dynamic pressure Generating portion (for example, a herringbone or spiral dynamic pressure groove) may be formed in the inner peripheral surface of the oil-impregnated bearing.

The machine part comprising a green compact according to the present invention has a sufficient strength, and hence is applicable not only in the field requiring less strength, such as a soft magnetic material part, but also to an oil-impregnated bearing as described in the above-mentioned embodiment, other slide members, or a metal backing of a composite bearing in which a resin, layer is formed on a slide surface.

### EXAMPLES

In order to confirm preferred conditions for the method of manufacturing a machine part, the following tests were performed. In each test, reduced iron powder and electrolytic copper powder were each used as metal powder, and an amide wax-based powder lubricant was used as a lubricant for compacting and forming. In addition, each green compact was formed into φ6 mm in inner diameter×φ12 mm in outer diameter×5 mm in length in an axial direction through uniaxial press forming of a floating die method using a mold made of SKD11. The lubricant was added in an amount of 0.7 wt. % with respect to the total weight of the metal powder. A batch-type heating furnace, whose atmosphere was controllable, was used for heating, unless otherwise specified. During the heating, the flow rates of an oxidizing gas and otherwise an inert gas or a reducing gas were set to 0.1 L/min and 2.0 L/min, respectively. A temperature increase rate during the heating was set to 10° C./min, and cooling was performed by furnace cooling to room temperature.

Test pieces obtained by changing various conditions were evaluated based on their radial crushing strengths measured and calculated in accordance with the method specified in JIS Z 2507. An average value of the radial crushing strength measured for three test pieces was used for the evaluation. A used testing device is Autograph AG-5000A manufactured by Shimadzu Corporation. The “radial crushing strength” refers to the strength of a cylindrical green compact determined based on a radial crushing load by a certain method, and the “radial crushing load” refers to a load at which the cylindrical green compact starts to break when compressed between two planes each parallel to its axis. The judgment criteria of the radial crushing strength (unit: MPa) were as follows: a case of less than 120 was judged as not acceptable (×), a case of 120 or more and less than 150 was judged as acceptable (∘), and a case of 150 or more was judged as good (⊚). Of the test pieces, one having a radial crushing strength of 120 MPa or more (acceptable or good) was taken as Example, and one having a radial crushing strength of less than 120 MPa (not acceptable) was taken as Comparative Example. The details of the tests are described below.

(a) Investigation on Green Density

Green compacts having a green density measured by a dimension measurement method of from 5.5 g/cm³ to 7.4 g/cm³ were produced through use of only reduced iron powder as base material metal powder, and were subjected to lubricant dewaxing at 350° C. for 90 minutes in a furnace purged with pure air, and then to oxidation through heating at 500° C. for 30 minutes. The conditions and evaluation results are shown in Table 1.

TABLE 1

| | | | | | Radial | |
|---|---|---|---|---|---|---|
| | | Green | Heating | | crushing | |
| | | density | conditions | Atmos- | strength | Judg- |
| | Material | g/cm³ | ° C. × min | phere | MPa | ment |
| Comparative | Only Fe | 5.5 | 500 × 30 | Pure air | 103 | X |
| Example 1 | | | | | | |
| Comparative | | 7.4 | | | 110 | X |
| Example 2 | | | | | | |
| Example 1 | | 5.8 | | | 145 | ◯ |
| Example 2 | | 6.0 | | | 160 | ⊚ |
| Example 3 | | 6.5 | | | 165 | ⊚ |
| Example 4 | | 7.0 | | | 153 | ⊚ |
| Example 5 | | 7.2 | | | 142 | ◯ |

When the green density is as low as less than 5.5 g/cm³, the strength of the green compact in a state before the heating is insufficient, with the result that chipping or breakage is liable to occur at the time of handling before the heating (a rattler value is high). In addition, even when the green compact having a low density as described above is heated in pure air, the radial crushing strength reaches at most about 100 MPa, which is less than 110 MPa, with which the machine part to be obtained is enough to withstand the use as a slide bearing or other machine parts.

Meanwhile, when the green density is more than 5.8 g/cm³, the chipping or breakage as described above is less liable to occur, and a radial crushing strength at a level exceeding 120 MPa is obtained after the heat treatment. A general sintered part is increased in strength along with an increase in density of the green compact. However, in the present invention, an increase In strength is achieved dominantly by network formation by the oxide film, rather than by fusion of particles. Therefore, when the density is too high, oxygen is not sufficiently supplied into the inside of the green compact, and thus the formation of the oxide film is limited to a surface layer region of the green compact, which tends to result in a decrease in strength contrarily. Further, when the density was increased up to 7.4 g/cm³, the radial crashing strength decreased to 110 MPa,

The above-mentioned results show that, when the green density falls within a range of from 5.8 g/cm³ to 7.2 /cm³, the green compact has a radial crushing strength of 120 MPa or more, and further, when the green density falls within a range of from 6.0 g/cm³ to 7.0 g/cm³, the green compact has a radial crushing strength of more than 150 MPa. Accordingly, it can be said that an appropriate range of the green density is from 5.6 g/cm³ to 7.2 g/cm³, preferably from 6.0 g/cm³ to 7.0 g/cm³.

(b) Investigation on Heating Temperature and Heating Time Period

The same green compact as in Example 2, which was formed of pure iron powder and had a density of 6.0 g/cm³, was heated at various temperatures for various time periods in pure air. Thus, an influence on the radial crushing strength was examined. The conditions except for the maximum temperature during heating and the time period of the heating are the same as those in Example 2, The conditions and evaluation results are shown in Table 2.

TABLE 2

| | | | | | Radial | |
|---|---|---|---|---|---|---|
| | | Green | Heating | | crushing | |
| | | density | conditions | Atmos- | strength | Judg- |
| | Material | g/cm³ | ° C. × min | phere | MPa | ment |
| Comparative | Only Fe | 6.0 | Without | — | 15 | X |
| Example 3 | | | treatment | | | |
| Comparative | | | 300 × 30 | Pure air | 76 | X |
| Example 4 | | | | | | |
| Comparative | | | 500 × 1 | | 82 | X |
| Example 5 | | | | | | |
| Example 6 | | | 350 × 30 | | 122 | ◯ |
| Example 7 | | | 400 × 30 | | 138 | ◯ |
| Example 8 | | | 450 × 30 | | 152 | ⊚ |
| Example 2 | | | 500 × 30 | | 160 | ⊚ |
| Example 9 | | | 600 × 30 | | 190 | ⊚ |
| Example 10 | | | 500 × 5 | | 154 | ⊚ |
| Example 11 | | | 500 × 30 | | 160 | ⊚ |
| Example 12 | | | 500 × 120 | | 171 | ⊚ |

First, without treatment (directly as the green compact), the radial crushing strength was as significantly low as 15 MPa. In addition, when the treatment temperature was 300° C., an increase in strength was insufficient and the radial crushing strength was less than 100 MPa. Meanwhile, when the treatment temperature was increased to 350° C. or more, the strength is increased up to 120 MPa or more. Further, when the treatment temperature falls within a range of from 450° C. to 600° C., the strength was increased up to 150 MPa or more. In addition, even when the treatment temperature was set to 500° C., the strength was not increased sufficiently for a treatment time period of 1 minute and remained at about 80 MPa. However, when the treatment time period was prolonged to 5 minutes or more, the strength was increased up to 150 MPa or more in each case. From those results, it can be said that an appropriate heating temperature is 350° C. or more, preferably 450° C. or more, and an appropriate treatment time period is 5 minutes or more.

(c) Investigation on Treatment Atmosphere

The same green compact as in Example 2, which was formed of pure iron powder and had a density of 6.0 g/cm³, was heated in various atmospheres. Thus, an influence of an atmosphere during heat treatment on the radial crushing strength was examined. The conditions except for the atmosphere during heating are the same as those in Example 2. In addition, “the atmosphere” shown in the column of Example 14 means not supplying a pure air gas but heating in a batch-type atmospheric furnace without atmosphere control, which is unlike the case of Example 2 shown as “pure air”. The conditions and evaluation results are shown in Table 3.

TABLE 3

| | | | | | Radial | |
|---|---|---|---|---|---|---|
| | | Green | Heating | | crushing | |
| | Ma- | density | conditions | | strength | Judg- |
| | terial | g/cm³ | ° C. × min | Atmosphere | MPa | ment |
| Comparative | Only | 6.0 | 500 × 30 | Hydrogen | 42 | X |
| Example 6 | Fe | | | | | |
| Comparative | | | | Nintrogen | 37 | X |
| Example 7 | | | | | | |
| Example 2 | | | | Pure air | 160 | ⊚ |
| Example 13 | | | | Oxygen | 178 | ⊚ |
| Example 14 | | | | The | 162 | ⊚ |
| | | | | atmosphere | | |

When a hydrogen atmosphere (reducing atmosphere) or a nitrogen atmosphere (inert atmosphere) is adopted as the atmosphere during heating, the strength is increased by a factor of two or more as compared to 15 MPa before the heat treatment, but falls short of 120 MPa, which is a required level. Meanwhile, when an oxygen atmosphere, or a pure air atmosphere or an atmosphere of the atmosphere containing oxygen is adopted, a radial crushing strength of 150 MPa or more is exhibited. It is shown that the strength is sufficiently increased.

Now, these results are considered in conjunction with the results of the “(b) Investigation on Heating Temperature and Heating Time Period” section. In the case of adopting an inert gas or a reducing gas, the strength is likely to be increased by fusion of part of particles of the iron powder. In Comparative Example 4 including heating at 300° C., the strength is likely to be increased insufficiently because the fusion does not occur at low temperature. The strength may be increased up to 120 MPa or more even in a non-oxidizing gas by increasing the treatment temperature, but in order to obtain a strength at a level of Examples 2, 13, and 14, heating at high temperature at the same level as in the conventional sintering is likely to be required. Meanwhile, from the fact that a radial crushing strength of 150 MPa or more is exhibited in Examples 2, 13, and 14 under the same heating conditions as in Comparative Examples 6 and 7, it can be said that, in addition to fusion of the particles of the iron powder, the formation of an oxide film network between the particles through heating in the oxidizing atmosphere is required for increasing the strength.

From the foregoing, it can be said that the oxidizing atmosphere, such as an oxygen atmosphere or a mixed gas atmosphere of oxygen and an inert gas, is important for sufficiently increasing the strength at a low temperature of 600° C. or less.

Further, an influence of the oxygen fraction in the atmosphere during heat treatment on the radial crushing strength was examined. In the beat treatment of the same green compact as in Example 3, which was formed of pure iron powder and had a density of 6.5 g/cm³, a nitrogen/oxygen two-component treatment atmosphere was adopted as a treatment atmosphere, and volume fractions of the components were changed. The atmosphere was controlled by setting the total flow rate of the two components, nitrogen and oxygen, to 2.0 L/min and changing the ratio between the flow rates of the components. The conditions including degreasing conditions and temperature increasing and decreasing conditions except for the atmosphere during heating are the same as those in Example 3. The conditions and evaluation results are shown in Table 4.

TABLE 4

| | | | | | | | Radial | |
|---|---|---|---|---|---|---|---|---|
| | | Green | Heating | Oxygen | Gas flow rate, | | crushing | |
| | | dentisty, | conditions | fraction, | L/min | | strength, | Judg- |
| | Material | g/cm³ | ° C. × min | vol. % | Nitrogen | Oxygen | MPa | ment |
| Comparative | Only Fe | 6.5 | 500 × 30 | 0 | 2 | 0 | 45 | X |
| Example 9 | | | | | | | | |
| Example 23 | | | | 2 | 1.96 | 0.04 | 150 | ⊚ |
| Example 24 | | | | 5 | 1.9 | 0.1 | 178 | ⊚ |
| Example 25 | | | | 10 | 1.8 | 0.2 | 173 | ⊚ |
| Example 26 | | | | 20 | 1.6 | 0.4 | 179 | ⊚ |
| Example 27 | | | | 50 | 1 | 1 | 184 | ⊚ |
| Example 28 | | | | 100 | 0 | 2 | 186 | ⊚ |

When the oxygen fraction in the treatment atmosphere was 2 vol % or more, the radial crushing strength was at a level of 150 MPa or more. In addition, the strength is roughly increased along with an increase in oxygen fraction, but when the oxygen fraction is 5 vol % or more, particularly 10 vol % or more, the strength is increased slowly. A lower oxygen fraction allows ensuring of the inner pores by virtue of a reduction in thickness of the oxide film in the inside of the green compact. Accordingly, it can be said that a green compact having a sufficient strength and a sufficient porosity can be obtained when the oxygen fraction in the treatment atmosphere is set to 2 vol % or more and 10 vol % or less (preferably 5 vol % or less).

(d) Investigation on Material

A green compact having a green density of 6.0 g/cm³ was obtained in Examples 15 to 18 in which electrolytic copper powder was added in an amount of from 20 wt. % to 80 wt. % based on Example 2 described above. In addition, a green compact comprising pure Al powder as a material for forming an oxide film without iron and copper as a main component was prepared, and taken as Comparative Example 8. However, the green density was 1.9 g/cm³ because the Al powder had a low true density and its compacting and forming was difficult. The conditions except for the material of the green compact and the density in Comparative Example 8 are the same as those in Example 2. The conditions and evaluation results are shown in Table 5.

TABLE 5

| | | | | | Radial | |
|---|---|---|---|---|---|---|
| | | Green | Heating | | crushing | |
| | | density | conditions | Atmos- | strength | Judg- |
| | Material | g/cm³ | ° C. × min | phere | MPa | ment |
| Comparative | Only Al | 1.9 | 500 × 30 | Pure | 41 | X |
| Example 8 | | | | air | | |
| Example 2 | Only Fe | 60 | | | 160 | ⊚ |
| Example 15 | Fe + | | | | 152 | ⊚ |
| | 20% Cu | | | | | |
| Example 16 | Fe + | | | | 147 | ◯ |
| | 40% Cu | | | | | |
| Example 17 | Fe + | | | | 134 | ◯ |
| | 60% Cu | | | | | |
| Example 18 | Fe + | | | | 128 | ◯ |
| | 80% Cu | | | | | |

In Examples 2 and 15 to 18, in which the green compact contained iron or copper as a main component, a radial crushing strength of 120 MPa or more was exhibited, and in the case of a copper ratio of 20 wt. % or less, a radial crushing strength of 150 MPa or more was exhibited. Meanwhile, in Comparative Example 8, in which the oxide film was expected to be formed through heating in the oxidizing atmosphere, and along with this, the strength was expected to be increased as in the case of the iron powder, the radial crushing strength remained at about 40 MPa.

From those results, it can be said that the method of the present invention is not applicable to all metals that can form the oxide film, and is remarkably successful when iron or copper is contained as a main component. However, a case in which the strength can be increased even when another metal is contained as a main component may be found by future investigations.

(e) Investigation on Presence or Absence of Lubricant Dewaxing Step (Degreasing Step)

In Example 2 described above, prior to the nesting step in pure air for forming the oxide film, dewaxing for the lubricant for forming was performed similarly in pure air. Herein, an investigation is made on dewaxing conditions based on the results of the cases of performing preliminary lubricant dewaxing in various atmospheres and the case of performing heating without the preliminary dewaxing step. The conditions except for the conditions of the dewaxing step before heating are the same as those in Example 2. The conditions and evaluation results are shown in Table 6.

TABLE 6

| | | | | | | Radial | |
|---|---|---|---|---|---|---|---|
| | | Green | Heating | At- | De- | crushing | |
| | Ma- | density | conditions | mos- | greasing | strength | Judg- |
| | terial | g/cm³ | ° C. × min | phere | step | MPa | ment |
| Exam- | Only | 6.0 | 500 × 30 | Pure | Present | 160 | ⊚ |
| ple 2 | Fe | | | air | (in pur | | |
| | | | | | air) | | |
| Exam- | | | | | Present | 172 | ⊚ |
| ple 19 | | | | | (in | | |
| | | | | | nitrogen) | | |
| Exam- | | | | | Present | 180 | ⊚ |
| ple 20 | | | | | (in | | |
| | | | | | vacuum) | | |
| Exam- | | | | | Absent | 133 | ◯ |
| ple 21 | | | | | | | |

A radial crushing strength of 120 MPa or more was exhibited in each case irrespective of the presence or absence of the dewaxing step for the lubricant for forming and the atmosphere during dewaxing. & higher strength was obtained in Examples 2, 19, and 20, in which the dewaxing step was performed, than in Example 21, in which the dewaxing step was not performed. In addition, in Example 20 including dewaxing in vacuum, in which the amount of the lubricant remaining in the inside of the green compact (residue) is presumed to be minimum, the highest strength of about 180 MPa is exhibited. From the fact, it can be said that the removal of the lubricant is effective for increasing the strength.

### REFERENCE SIGNS LIST

1 oil-impregnated bearing
2 shaft
10 iron particle
11 iron oxide film
20 copper particle
21 copper oxide film

1. A machine part, comprising a green compact in which metal powder particles are bonded to each other with an oxide film formed on a surface of each particle,
wherein a maximum thickness of the oxide film in a region at a depth of 300 μm±10 μm from a surface of the green compact is 1 μm or less.

2. The machine part according to claim 1, wherein a maximum thickness of the oxide film in a region at a depth of 30 μm or less from the surface of the green compact is twice or more as large as the maximum thickness of the oxide film in the region at a depth of 300 μm±10 μm from the surface of the green compact.

3. The machine part according to claim 1, wherein the green compact comprises iron and copper as a main component.

4. The machine part according to claim 1, wherein the green compact has a porosity of 8% or more.

5. The machine part according to claim 1, wherein the machine part is used as an oil-impregnated bearing having a bearing surface on an inner peripheral surface and having inner pores impregnated with an oil.

6. The machine part according to claim 5, wherein the machine part comprises a dynamic pressure generating portion in the bearing surface.

7. A method of manufacturing a machine part, the method comprising the steps of:
compacting and forming raw material powder containing metal powder to provide a green compact; and
subjecting the green compact to heat treatment in an oxidizing atmosphere to allow metal powder particles to be bonded to each other with an oxide film formed on a surface of each particle,
conditions of the heat treatment being set so that a maximum thickness of the oxide film in a region at a depth of 300 μm±10 μm from a surface of the green compact is 1 μm or less.

8. The method of manufacturing a machine part according to claim 7, wherein the heat treatment is performed in any one of an oxygen atmosphere, an air atmosphere, and an atmosphere of an oxidizing gas obtained by mixing an inert gas with oxygen or air.

9. The method of manufacturing a machine part according to claim 8, wherein the oxidizing gas has an oxygen fraction of 10 vol % or less.
